(19) United States
(12) Patent Application Publication
(10) Pub. No.: US 2007/0169768 A1
(43) Pub. Date: Jul. 26, 2007

(54) Barbeque grill having foldable device

(76) Inventor: Kiosky Chung, Taichung City (TW)

Correspondence Address: BANGER SHIA, 204 CANYON CREEK, VICTORIA, TX, 77901-3695, US

(21) Appl. No.: 11/339,857

(22) Filed: Jan. 26, 2006

(51) Int. Cl. A47J 37/00; F24B 3/00; F24C 5/00

(52) U.S. Cl. 126/25 R; 126/50

(57) ABSTRACT

A barbeque grill includes a cabinet, and a foldable device including a side frame mounted on the cabinet, and a support plate pivotally mounted on the side frame. Thus, the support plate of the foldable device is expanded outward from and perpendicular to the side frame to increase the placement space of the barbeque grill, thereby facilitating a user employing the barbeque grill. In addition, the support plate of the foldable device is fully folded into and secured in the side frame when not in use, thereby facilitating the user storing and carrying the barbeque grill.

### BACKGROUND OF THE INVENTION

1. Field of the Invention

The present invention relates to a barbeque grill, and more particularly to a barbeque grill having a foldable device.

2. Description of the Related Art

A conventional barbeque grill comprises a cabinet containing a rack therein for placing items, and a grill body mounted on the top of the cabinet and having two side boards for placing items. The barbeque grill needs to store many items, such as the sauce cans, dishes, clips, charcoals, firelighter, water sprayer and the like. However, the placement space of the barbeque grill is not large enough to store so many items, thereby causing inconvenience to the user when operating the barbeque grill.

### SUMMARY OF THE INVENTION

The present invention is to mitigate and/or obviate the disadvantage of the conventional barbeque grill.

The primary objective of the present invention is to provide a barbeque grill having a foldable device.

Another objective of the present invention is to provide a barbeque grill, wherein the support plate of the foldable device is expanded outward from and perpendicular to the side frame for use with a user to increase the placement space of the barbeque grill, thereby facilitating the user employing the barbeque grill.

A further objective of the present invention is to provide a barbeque grill, wherein the support plate of the foldable device is fully folded into and secured in the side frame when not in use, thereby facilitating the user storing and carrying the barbeque grill.

A further objective of the present invention is to provide a barbeque grill, wherein the foldable device has a simplified construction, thereby decreasing the costs of fabrication.

In accordance with the present invention, there is provided a barbeque grill, comprising:

a cabinet;

a foldable device mounted on the cabinet and including a side frame mounted on the cabinet, and a support plate pivotally mounted on the side frame and pivotable relative to the side frame between a first position where the support plate is perpendicular to the side frame and a second position where the support plate is parallel with the side frame.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a barbeque grill in accordance with the preferred embodiment of the present invention;

FIG. 2 is a locally perspective enlarged view of the barbeque grill as shown in FIG. 1;

FIG. 3 is an exploded perspective view of the barbeque grill as shown in FIG. 2;

FIG. 4 is a side plan view of the barbeque grill as shown in FIG. 2;

FIG. 5 is a schematic operational view of the barbeque grill as shown in FIG. 4;

FIG. 6 is a schematic operational view of the barbeque grill as shown in FIG. 5;

FIG. 7 is a schematic operational view of the barbeque grill as shown in FIG. 6;

FIG. 8 is a schematic operational view of the barbeque grill as shown in FIG. 7;

FIG. 9 is a schematic operational view of the barbeque grill as shown in FIG. 8; and

FIG. 10 is a perspective view of the barbeque grill as shown in FIG. 1.

### DETAILED DESCRIPTION OF THE INVENTION

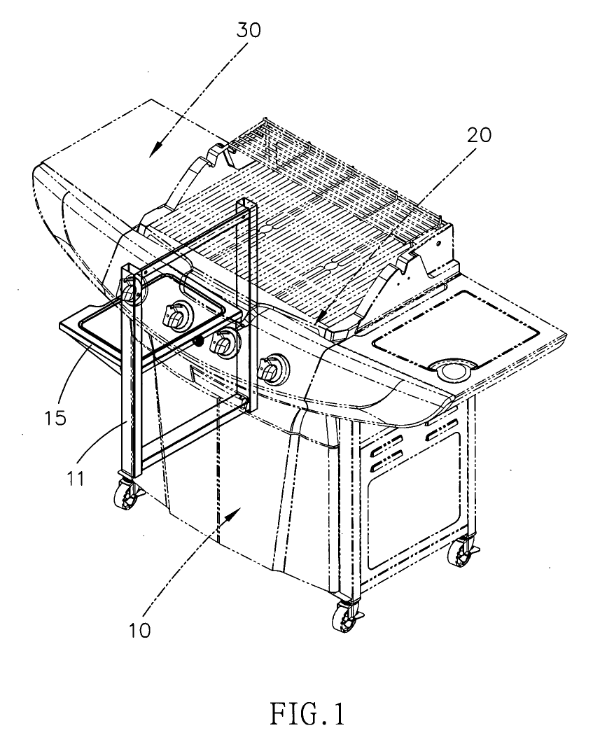

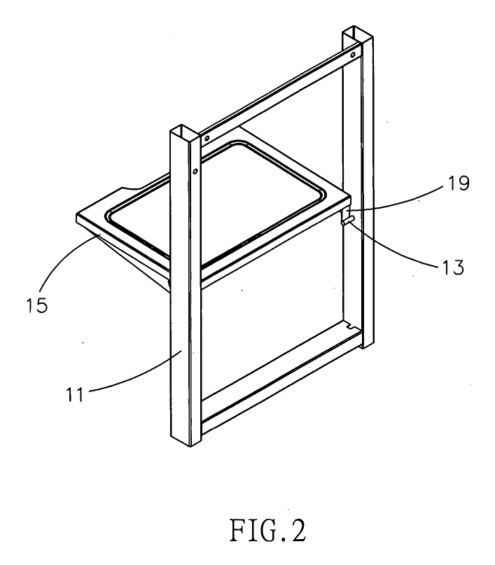

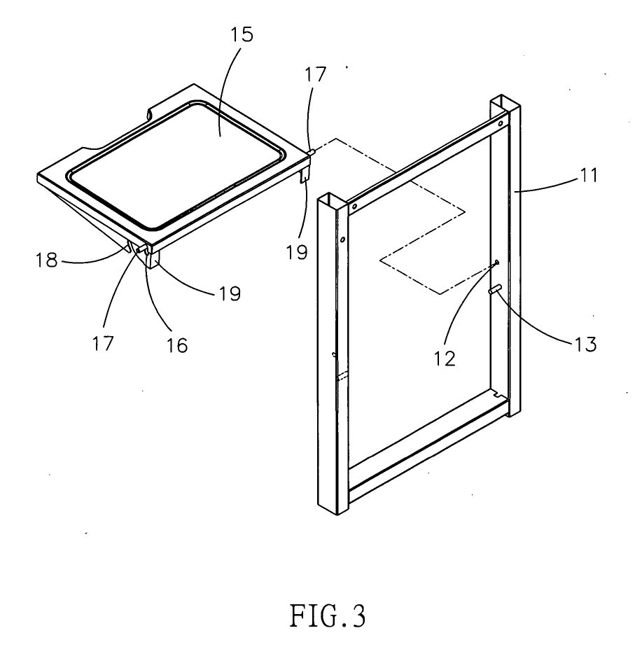

Referring to the drawings and initially to FIGS. 1-4, a barbeque grill in accordance with the preferred embodiment of the present invention comprises a cabinet 10, a grill body 20 mounted on a top of the cabinet 10 and having two side boards 30, and a foldable device mounted on the cabinet 10.

The foldable device is mounted on at least one side of the cabinet 10 or each of two sides of the cabinet 10. The foldable device includes a side frame 11 mounted on the cabinet 10, a support plate 15 pivotally mounted on the side frame 11 and pivotable relative to the side frame 11 between a first position where the support plate 15 is perpendicular to the side frame 11 and a second position where the support plate 15 is parallel with the side frame 11, and a pivot shaft 17 secured to the side frame 11 and extended through the support plate 15 so that the support plate 15 is pivotally mounted on the side frame 11.

The side frame 11 is a substantially rectangular hollow body and has two sides each provided with a stop bar 13 and formed with a positioning hole 12 located above the stop bar 13. The positioning hole 12 and the stop bar 13 of the side frame 11 are located at a mediate portion of each of the two sides of the side frame 11.

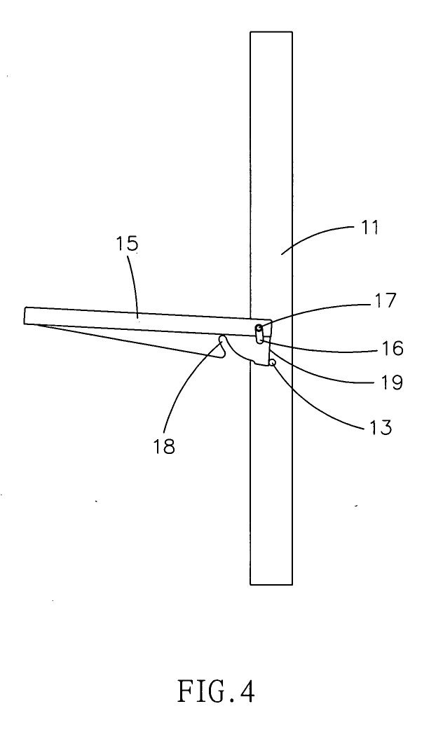

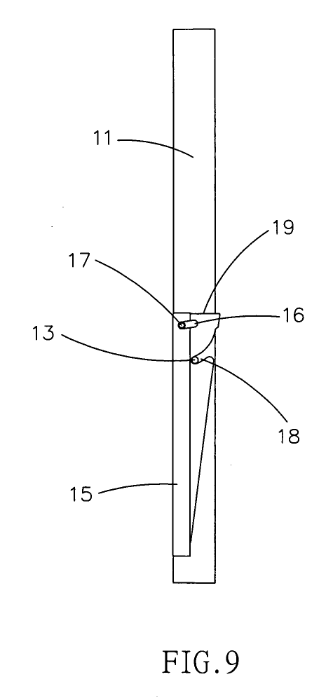

The support plate 15 has two sides each formed with a slide slot 16 and an arcuate opening 18 and provided with a resting piece 19. The slide slot 16 of the support plate 15 is perpendicular to the support plate 15. The resting piece 19 of the support plate 15 is perpendicular to the support plate 15 and is rested on the respective stop bar 13 of the side frame 11 when the support plate 15 is perpendicular to the side frame 11 as shown in FIG. 4. The arcuate opening 18 of the support plate 15 is aligned with the respective stop bar 13 of the side frame 11 when the support plate 15 is parallel with the side frame 11, so that the respective stop bar 13 of the side frame 11 is inserted into the arcuate opening 18 of the support plate 15 as shown in FIG. 9.

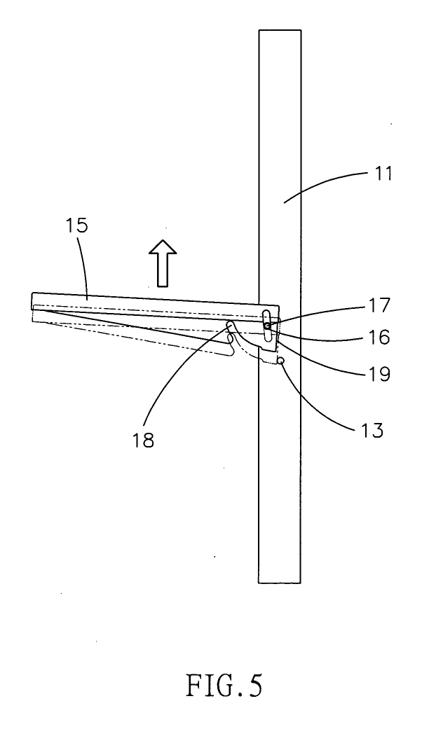

The pivot shaft 17 has two ends each extended through the respective slide slot 16 of the support plate 15 and secured in the respective positioning hole 12 of the side frame 11. The pivot shaft 17 is slidably mounted in the slide slot 16 of the support plate 15, so that the support plate 15 is movable relative to the side frame 11. The support plate 15 is movable upward and downward relative to the side frame 11 between a first position as shown in FIG. 4 where the pivot shaft 17 is located at an uppermost position of the slide slot 16 of the support plate 15, so that the resting piece 19 of the support plate 15 is rested on the respective stop bar 13 of the side frame 11, and a second position as shown in FIG. 5 where the pivot shaft 17 is located at a lowermost position of the slide slot 16 of the support plate 15, so that the resting piece 19 of the support plate 15 is detached from the respective stop bar 13 of the side frame 11.

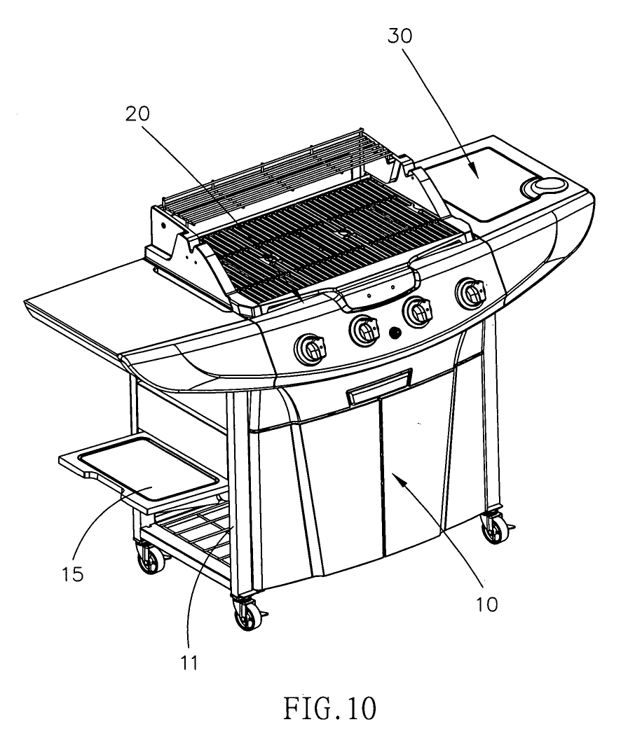

As shown in FIGS. 1 and 10, the support plate 15 is expanded outward from and perpendicular to the side frame 11.

In operation, when the support plate 15 is perpendicular to the side frame 11 as shown in FIG. 4, the pivot shaft 17 is located at the uppermost position of the slide slot 16 of the support plate 15, so that the resting piece 19 of the support plate 15 is rested on the respective stop bar 13 of the side frame 11 to secure the support plate 15 to the side frame 11. Thus, the support plate 15 is expanded outward from and secured to the side frame 11.

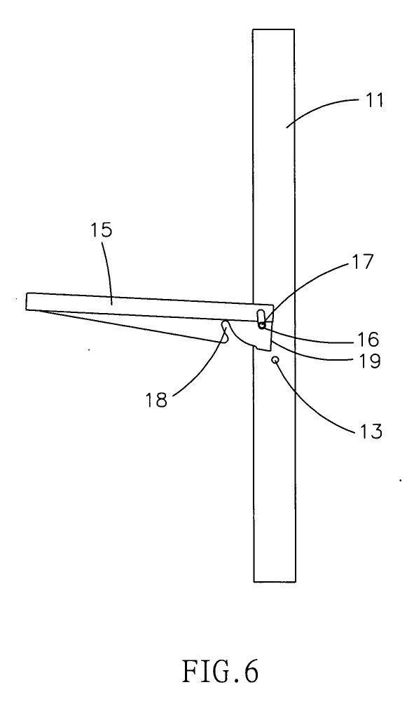

As shown in FIGS. 5 and 6, the support plate 15 is movable upward relative to the side frame 11 until the pivot shaft 17 is located at the lowermost position of the slide slot 16 of the support plate 15, so that the resting piece 19 of the support plate 15 is detached from the respective stop bar 13 of the side frame 11. Thus, the support plate 15 is pivotable relative to the side frame 11.

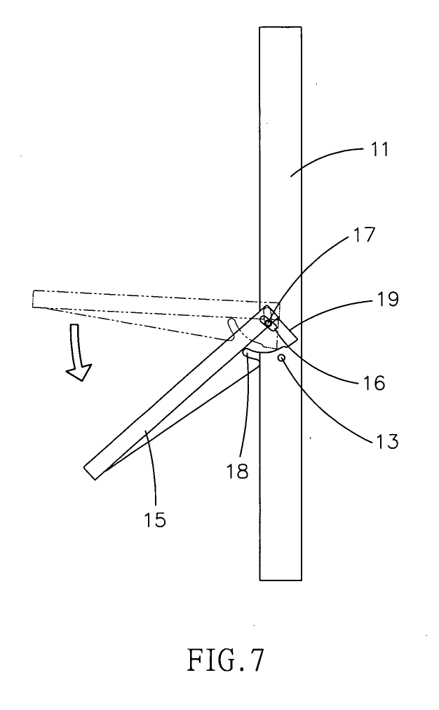

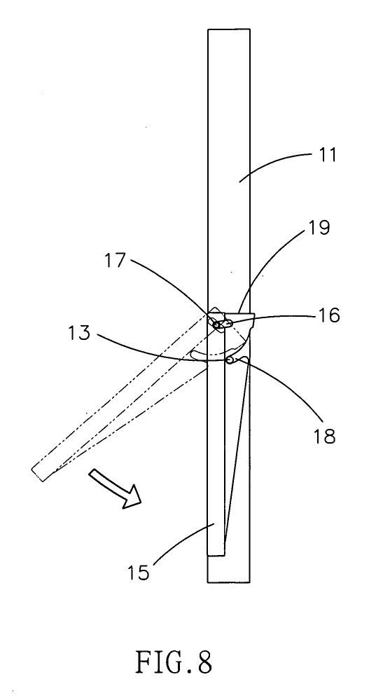

As shown in FIGS. 7-9, the support plate 15 is pivotable downward relative to the side frame 11 to move the arcuate opening 18 toward the respective stop bar 13 of the side frame 11 until the arcuate opening 18 of the support plate 15 is aligned with the respective stop bar 13 of the side frame 11, so that the respective stop bar 13 of the side frame 11 is inserted into the arcuate opening 18 of the support plate 15 as shown in FIG. 9. Thus, when the support plate 15 is parallel with the side frame 11, the respective stop bar 13 of the side frame 11 is inserted into the arcuate opening 18 of the support plate 15 to secure the support plate 15 to the side frame 11, so that the support plate 15 is fully folded into and secured in the side frame 11.

Accordingly, the support plate 15 of the foldable device is expanded outward from and perpendicular to the side frame 11 for use with a user to increase the placement space of the barbeque grill, thereby facilitating the user employing the barbeque grill. In addition, the support plate 15 of the foldable device is fully folded into and secured in the side frame 11 when not in use, thereby facilitating the user storing and carrying the barbeque grill. Further, the foldable device has a simplified construction, thereby decreasing the costs of fabrication.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A barbeque grill, comprising:
a cabinet;
a foldable device mounted on the cabinet and including a side frame mounted on the cabinet, and a support plate pivotally mounted on the side frame and pivotable relative to the side frame between a first position where the support plate is perpendicular to the side frame and a second position where the support plate is parallel with the side frame.

2. The barbeque grill in accordance with claim 1, wherein the foldable device is mounted on at least one side of the cabinet.

3. The barbeque grill in accordance with claim 1, wherein the foldable device is mounted on each of two sides of the cabinet.

4. The barbeque grill in accordance with claim 1, wherein the side frame is a substantially rectangular hollow body.

5. The barbeque grill in accordance with claim 1, wherein the side frame has two sides each provided with a stop bar and formed with a positioning hole located above the stop bar, and the support plate has two sides each formed with a slide slot and an arcuate opening and provided with a resting piece.

6. The barbeque grill in accordance with claim 5, wherein the positioning hole and the stop bar of the side frame are located at a mediate portion of each of the two sides of the side frame.

7. The barbeque grill in accordance with claim 5, wherein the slide slot of the support plate is perpendicular to the support plate.

8. The barbeque grill in accordance with claim 5, wherein the resting piece of the support plate is perpendicular to the support plate.

9. The barbeque grill in accordance with claim 5, wherein the resting piece of the support plate is rested on the respective stop bar of the side frame when the support plate is perpendicular to the side frame.

10. The barbeque grill in accordance with claim 5, wherein the arcuate opening of the support plate is aligned with the respective stop bar of the side frame when the support plate is parallel with the side frame, so that the respective stop bar of the side frame is inserted into the arcuate opening of the support plate and the support plate is folded into the side frame.

11. The barbeque grill in accordance with claim 5, wherein the foldable device further includes a pivot shaft secured to the side frame and extended through the support plate so that the support plate is pivotally mounted on the side frame.

12. The barbeque grill in accordance with claim 11, wherein the pivot shaft has two ends each extended through the respective slide slot of the support plate and secured in the respective positioning hole of the side frame.

13. The barbeque grill in accordance with claim 12, wherein the pivot shaft is slidably mounted in the slide slot of the support plate, so that the support plate is movable relative to the side frame.

14. The barbeque grill in accordance with claim 13, wherein the support plate is movable upward and downward relative to the side frame between a first position where the pivot shaft is located at an uppermost position of the slide slot of the support plate, so that the resting piece of the support plate is rested on the respective stop bar of the side frame, and a second position where the pivot shaft is located at a lowermost position of the slide slot of the support plate, so that the resting piece of the support plate is detached from the respective stop bar of the side frame.

15. The barbeque grill in accordance with claim 1, wherein the support plate is perpendicular to the side frame when the support plate is expanded outward from the side frame.

16. The barbeque grill in accordance with claim 14, wherein when the support plate is perpendicular to the side frame, the pivot shaft is located at the uppermost position of the slide slot of the support plate, so that the resting piece of the support plate is rested on the respective stop bar of the side frame to secure the support plate to the side frame.

17. The barbeque grill in accordance with claim 14, wherein the support plate is pivotable relative to the side frame when the resting piece of the support plate is detached from the respective stop bar of the side frame.

18. The barbeque grill in accordance with claim 17, wherein the support plate is pivotable downward relative to the side frame to move the arcuate opening toward the respective stop bar of the side frame until the arcuate opening of the support plate is aligned with the respective stop bar of the side frame, so that the respective stop bar of the side frame is inserted into the arcuate opening of the support plate.
